(19) United States
(12) Patent Application Publication
(10) Pub. No.: US 2010/0046221 A1
(43) Pub. Date: Feb. 25, 2010

(54) LED Source Adapted for Light Bulbs and the Like

(76) Inventors: Jason Loomis Posselt, San Jose, CA (US); Michael Solomensky, Fremont, CA (US); Steven D. Lester, Palo Alto, CA (US); Ghulam Hasnain, Palo Alto, CA (US)

Correspondence Address: THE LAW OFFICES OF CALVIN B. WARD, 18 CROW CANYON COURT, SUITE 305, SAN RAMON, CA, 94583, US

(21) Appl. No.: 12/194,134

(22) Filed: Aug. 19, 2008

(51) Int. Cl. F21S 4/00; H01J 9/24; F21V 15/00

(52) U.S. Cl. 362/249.02; 445/23; 362/373

(57) ABSTRACT

A light source and method for making the same are disclosed. The light source includes a housing, a drive assembly, and an LED. The housing has an interior compartment enclosed in an outer surface having a heat dissipating surface and first and second power terminals that are accessible from outside the interior compartment. The drive assembly is located in the interior compartment and electrically connected to the first and second power terminal. The LED is directly attached to the heat dissipating surface and electrically insulated therefrom, the LED having first and second LED power contacts. The housing has first and second housing power terminals disposed outside the housing, electrically isolated from the heat-dissipating surface, and connected to the drive assembly. A first conductor connects the first LED power contact to the first housing power terminal. A second conductor connects the LED second power contact to the second housing power terminal.

### BACKGROUND OF THE INVENTION

Light emitting diodes (LEDs) are an important class of solid-state devices that convert electric energy to light. Improvements in these devices have resulted in their use in light fixtures designed to replace conventional incandescent and fluorescent light sources. The LEDs have significantly longer lifetimes and, in some cases, significantly higher efficiency for converting electric energy to light.

LEDs are particularly attractive as replacements for incandescent bulbs in flashlights and other battery powered devices. LEDs have significantly longer lifetimes than incandescent bulbs and light conversion efficiencies that are several times the efficiency that can be achieved with conventional incandescent bulbs. The increased light conversion efficiency extends the lifetime of the batteries used to power the flashlight, and hence, battery replacement is reduced. In addition, LED-based lights provide increased ruggedness relative incandescent lighting, and hence, are better adapted to portable lighting applications.

In addition, LEDs have lifetimes that are greater than the lifetime of the typical flashlight. Hence, replacement of the LED is seldom needed during the lifetime of the flashlight. This feature is particularly attractive in flashlight design, as the number of different bulbs used in flashlights is quite high, and hence, finding the correct bulb can be time consuming. In the case of an LED-based flashlight, sufficient replacement bulbs can be included with the flashlight to last for the expected lifetime of the flashlight.

Unfortunately, the amount of light generated by a single LED is limited. Individual LEDs are limited to a few watts of power, and hence, even thought the light output per watt is significantly greater that an incandescent light source, many applications of interest require multiple LEDs to provide sufficient light. For example, flashlights and lighting systems used with infra red cameras typically include an array of individually packaged LEDs. The cost of such systems is substantially increased by the need to accommodate the individually packaged components and the installation of those components.

Heat dissipation is also a significant problem with high power LED light sources. The conversion efficiency of electrical power to light in an LED decreases with increasing junction temperature within the LED. Hence, removing heat from the LEDs is a major factor in the design of any LED light source that is to generate significant amounts of heat. If the heat is not efficiently removed, the conversion efficiency, and hence, the amount of light that can be generated, is substantially reduced.

Various packaging schemes have been devised to remove heat from the LEDs. One class of heat removal scheme relies on moving the heat from the LEDs to the metallic core of a printed circuit board on which the LEDs are mounted. The large area of the printed circuit board can then be utilized to dissipate the heat to the ambient environment or a secondary heat sink that is integrated into the assembly without necessitating a large increase in temperature. Typically, the LEDs are mounted on a metal surface within the package that collects the heat from the individual LEDs. This surface has an area that is much larger than the surface area of the LED dies; hence, if this surface is placed in good thermal contact with the printed circuit board core, the temperature of the LED die can be maintained at or slightly above that of the printed circuit board core.

This type of heat transfer scheme has a number of limitations. First, the bonding of the heat transfer surface of the package to the printed circuit board core, or an intermediate heat transfer surface, introduces some degree of thermal resistance, which in turn, increases the temperature at which the LEDs must operate to overcome this thermal resistance.

Second, the packages may require that the heat transfer surface be one of the power contacts of the LED. This limits the electrical configuration of the LEDs in a multiple LED light source to typically an arrangement in which the LEDs are connected in parallel. However, for many applications, a series connected array of LEDs is preferred to assure that the same current flows through each LED and that the voltages needed to drive the LEDs are high enough to provide efficient power transfer to the LEDs.

Third, the manufacturer of a device that is to incorporate a multiple LED source is limited by the available packaging schemes that are provided by the LED manufacturer. Hence, the manufacturer must introduce design limitations that would not necessarily be introduced if the use of prepackaged LEDs products were not required. For example, many heat transfer packages are surface mount packages in which the heat transfer contact and the power contacts are located on the bottom surface of the LED package so that the package can be mounted on a printed circuit board having mating pads by a solder reflow process. Hence, the device manufacturer must conform the printed circuit board's LEDs locations to have such pads on a common plane. Since the heat transfer surface must be thermally connected to the printed circuit board core that is below the surface on which the power contacts are located, a large area thermally conductive via must be provided to connect the heat transfer surface of the LED to the printed circuit board core.

Finally, it should be noted that prepackaged LEDs limit the configuration of the individual LEDs in the final product. The size of the LED packages is significantly larger than an LED die. Hence, to provide a multiple LED light source, an array of packages must be mounted on the printed circuit board or a multi-LED package having a configuration determined by the package manufacturer must be utilized. In products requiring a multi-LED light source with the LEDs in a particular arrangement, this limitation can pose significant problems.

### SUMMARY OF THE INVENTION

The present invention includes a light source and method for making the same. The light source includes a housing and an LED. The housing has an interior compartment enclosed in an outer surface having a heat dissipating surface and first and second LED power terminals that are accessible from outside the interior compartment. The LED is directly attached to the heat dissipating surface and electrically insulated therefrom, the LED having first and second LED power contacts. The light source also includes first and second housing power terminals disposed outside the housing, electrically isolated from the heat dissipating surface, the LED power contacts being powered when a potential difference is applied between the first and second housing power terminals. A first conductor connects the first LED power contact to the first LED power terminal, and a second conductor connects the LED second power contact to the second LED power terminal.

In one aspect of the invention, the light source includes a drive assembly electrically connected to the first and second housing power terminal and the first and second LED power terminals. The drive assembly is located in the interior compartment and provides power to the first and second LED power terminals.

In another aspect of the invention, the light source includes a protective cap covering the LED and the first and second conductors. The protective cap can include a transparent material.

In another aspect of the invention, the first and second LED power terminals include conducting members connected to the drive assembly that pass through first and second holes in the housing. The first conducting member could includes a cylindrical conductor extending from the housing and having a cross-sectional area sufficient to accept a wire bond.

In a further aspect of the invention, the light source could include a plurality of LEDs attached to the heat dissipating surface, in which two of the LEDs are connected together by a wire bond.

### BRIEF DESCRIPTION OF THE DRAWINGS

FIG. 1 is a cross-sectional view of a portion of a device 20 having an integrated light source according to one aspect of the present invention.

FIG. 2 is a cross-sectional view of an LED-based bulb for use in a flashlight or the like.

FIG. 3 is a cross-sectional view of a bulb that utilizes another aspect of the present invention.

FIG. 4 is a cross-sectional view of a bulb that utilizes a somewhat simpler connection scheme.

FIG. 5 is a cross-sectional view of a light bulb that has a housing with a base that has screw threads.

FIG. 6 is an end view of bulb having a plurality of LEDs.

### DETAILED DESCRIPTION OF THE PREFERRED EMBODIMENTS OF THE INVENTION

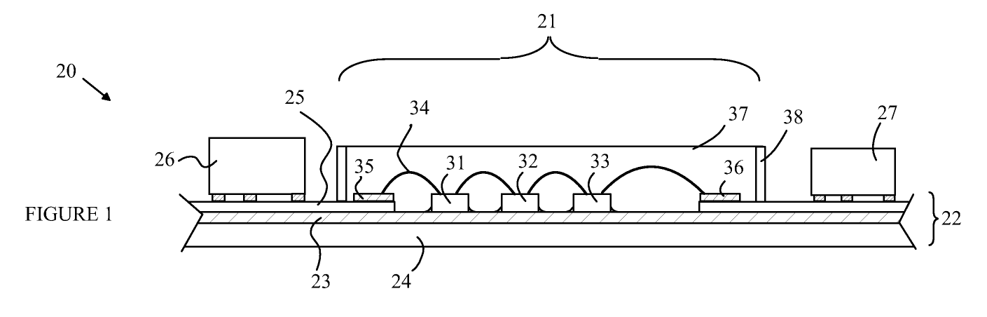

The manner in which the present invention provides its advantages can be more easily understood with reference to FIG. 1, which is a cross-sectional view of a portion of a device 20 having an integrated light source 21 according to one aspect of the present invention as part of the device. Device 20 is assumed to be more than just a light source. That is, device 20 performs functions other than controlling light 21. Light source 21 is merely a component of device 20 that is utilized in carrying out a more general processing and/or control function. Device 20 is constructed on a printed circuit board 22 having a metal core 23 that dissipates heat to the ambient surroundings. Metal core 23 could be constructed over a substrate 24 having additional metal layers for routing signals. In some embodiments, substrate 24 could be absent. Printed circuit board 22 also includes a number of wiring layers 25 over core 23. The various connections needed to operate components such as components 26 and 27 that are part of device 20 are run in these layers. At least one of the components provides functions that are independent of the control of the light from light source 21.

Light source 21 is constructed by bonding each of the LEDs to the surface of core 23 using a heat-conducting adhesive. If the LED provides electrical isolation of its power contacts from the bottom surface of the LED, the adhesive can be a conducting adhesive such as solder. The individual LEDs are connected together by wire bonds such as wire bond 34 to form a series chain comprising LEDs 31-33. The series chain is connected to two power terminals 35 and 36, which are connected to traces on printed circuit board 22.

After the LEDs have been connected with the wire bonds, the LEDs and wire bonds are encapsulated in a clear material to form a protective cap 37. In one aspect of the invention, protective cap 37 is formed by attaching a ring 38 to the surface of printed circuit board 22 and then filling the ring with a clear material such as silicone. However, other methods for providing the protective cap can be utilized. For example, a droplet of silicone or other material can be placed over the LEDs. In another aspect of the invention, the protective cap is formed separately and is placed over the LEDs leaving an air gap between the LEDs and the top surface of the protective cap. The protective cap and/or the encapsulant within the cap can include phosphor materials to convert the wavelength of the light emitted by the LEDs to light of the desired spectral composition.

It should be noted that the placement of the LEDs in device 20 can be altered without changing the structure of the printed circuit board. The number of LEDs, placement of those LEDs, and interconnections of those LEDs are determined by the device that places the LED containing dies on the printed circuit board core and by the wire bonding system that makes the specific wire bonds. The operations of both of these fabrication devices are controlled by computer programs and data files that can be altered independent of the printed circuit board so long as the printed circuit board has sufficient terminals to make the final connections between the light source in the printed circuit board core region and the printed circuit board. Accordingly, one printed circuit board design can be utilized with a number of different devices.

It should also be noted that other dies could be placed in the printed circuit board core region and connected to the LEDs. For example, LED light sources often include control chips that provide a constant current source for driving the LEDs. In addition, LED light sources that utilize a plurality of chips that emit light in different spectral bands often include controllers that regulate the intensity of light generated in each spectral band to generate light that is perceived to be of a specific color by a human observer. These controllers could likewise be mounted in the printed circuit board core region and connected to the LEDs rather than on the printed circuit board traces if the controller is specific to the particular light source implemented in the core region.

The embodiments of the present invention discussed above are directed to devices in which the LED-based light source is integrated directly on the device without any intermediate packaging to provide a completed final product. However, the present invention can also be utilized to provide a sub-component of a larger system.

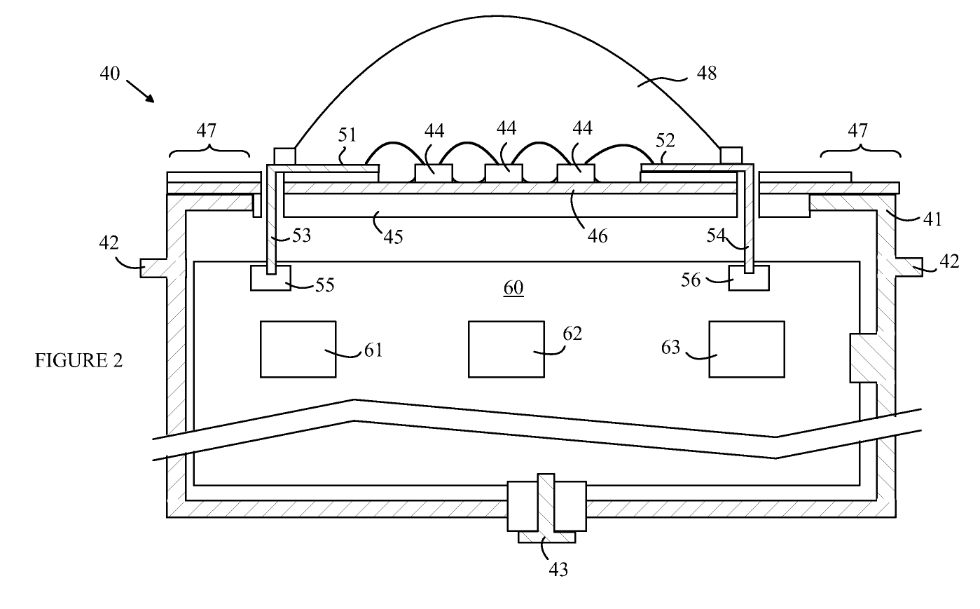

Refer now to FIG. 2, which is a cross-sectional view of an LED-based bulb for use in a flashlight or the like. Bulb 40 includes a housing 41 that provides the base of bulb 40 and has outside dimensions that match those of the conventional incandescent bulb that bulb 40 is designed to replace. In particular, housing 41 includes a flange 42 that mates with a corresponding structure in a lighting device such as a flashlight to provide mechanical alignment of the bulb with the lighting device and one of the power contacts for powering the bulb. The second power contact 43 is provided on the bottom surface of housing 42. Housing 42 also provides a heat dissipation surface for transferring heat generated by LEDs 44 to surfaces of the light source, and eventually, to the air outside the light source.

The light generating component of bulb 40 is provided by an LED light source that is constructed on a substrate 45 having a heat transfer core 46. Substrate 45 provides mechanical alignment with an opening in housing 41 and provides additional mechanical strength. Heat transfer core 46 is in thermal contact with housing 41 in the regions shown at 47. The thermal contact can be provided by bonding heat transfer core 46 to housing 41 using a heat conducting bonding agent such as a heat conducting epoxy or solder.

The light source component is constructed in a manner similar to that described above with reference to FIG. 1. The individual LEDs 44 are bonded to heat core 46 by a heat conducting bonding agent. The individual LEDs are electrically isolated from heat conducting core 46 either by an insulating layer within the chip or via a separate electrical isolation process such as an insulating bonding agent. The number and placement of the LEDs is determined by the desired light output.

The LEDs are connected internally by wire bonds 48. The particular connection configuration will be determined by the specific application. In the example shown in FIG. 2, the LEDs are connected in series. However, arrangements in which a number of series connected strings of LEDs are connected in parallel to power terminals 51 and 52 could also be utilized. In addition, separate power terminals could be provided for each string of LEDs.

The LEDs are encapsulated within a dome 48 that protects the dies from the environmental conditions outside the bulb. Dome 48 can be filled with a clear material to improve light extraction from the LEDs. In addition, dome 48 can include phosphors or diffusing agents for converting the optical spectrum generated by the LEDs to a different optical spectrum and/or mixing the light generated by the phosphors and/or the separate LEDs. For example, LEDs 44 could generate blue light and dome 48 could contain yellow emitting phosphors in a clear carrier that are excited by the blue light. The resultant optical spectrum is perceived by a human observer to be white if the ratio of the blue to yellow light in the output of the light source is correctly chosen.

Terminals 51 and 52 are part of leads 53 and 54, respectively. These leads extend through heat transfer core 46 and substrate 45 and are electrically isolated therefrom. Leads 53 and 54 are connected to pads 55 and 56, respectively, on a printed circuit board 60 having chips 61-63. In addition to providing electrical connections between printed circuit board 60 and the light source section, leads 53 and 54 can be utilized to mechanically bond the light source section to printed circuit board 60, and hence, help to secure printed circuit board within bulb 40.

Printed circuit board 60 includes one or more integrated circuits that provide control and/or power for the LEDs in the light source section of the bulb. The connections between these circuits and other parts of printed circuit board 60 have been omitted to simplify the drawing.

It should be noted that substrate 45 is optional in bulb 40. In the absence of substrate 40, the light source component could be aligned by matching the edge of heat transfer core 46 to the edge of housing 41, or by providing some additional feature on the bottom surface of heat transfer core 46 that engages the edges of the opening in housing 41 to align the light source component with housing 41.

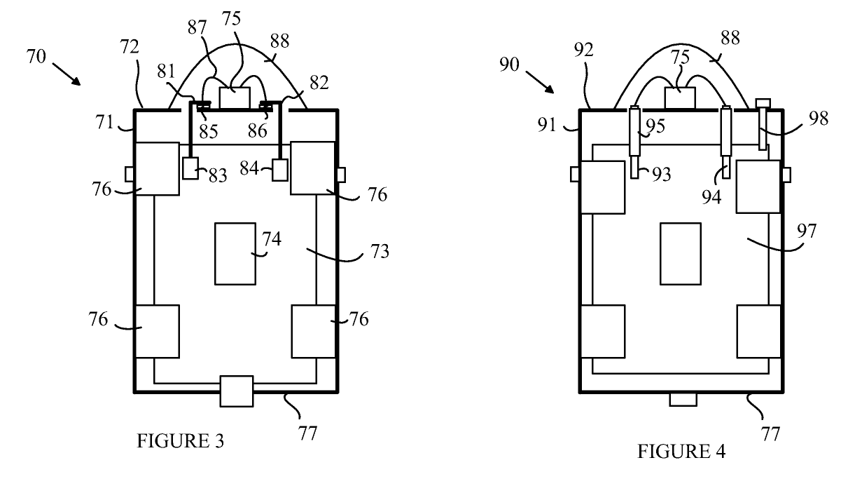

Refer now to FIG. 3, which is a cross-sectional view of a bulb 70 that utilizes another aspect of the present invention. Bulb 70 has a housing 71 that include a top surface 72 that provides the heat transfer function. Housing 71 holds a small printed circuit board 73 that contains an integrated circuit 74 that provides the driving circuitry for LED 75. Printed circuit board 73 is positioned within housing 71 by spacers 76 by sliding printed circuit board 73 through an opening in the surface 77 of housing 71.

LED 75 is bonded to surface 72 by a heat-conducting adhesive in a manner analogous to that discussed above. LED 75 is connected to the drive circuitry on printed circuit board 73 by leads 81 and 82. Leads 81 and 82 are “L” shaped strips of metal that pass through holes in surface 72 and engage clips 83 and 84 on printed circuit board 73. The leads are inserted through the holes in surface 72 into clips 83 and 84 from outside housing 71. Insulating pads 85 and 86 electrically isolate leads 81 and 82, respectively, from surface 72. Insulating pads 85 and 86 can be formed from layers of electrically insulating adhesive such as epoxy that are applied to surface 72 prior to inserting leads 81 and 82 into clips 83 and 84. Insulating pads 85 and 86 may also be formed in the fabrication of housing 71 via plating, coating, or treating of the surface. In such embodiments, leads 81 and 82 can fix the position of printed circuit board 73 within housing 71 provided clips 83 and 84 only allow insertion of the leads and not removal of the leads.

Once leads 85 and 86 are attached to surface 72, LED 75 is bonded to surface 72 and connected to leads 81 and 82 by wire bonds such as wire bond 87. LED 75 and the wire bonds are then encapsulated in a dome 88 as discussed above. In the embodiment shown in FIG. 3, dome 88 is formed from a drop of silicone or similar material that is cured to form a solid structure. However, as noted above, other forms of encapsulating dome could be utilized.

Bulb 70 only includes one LED. However, a plurality of LEDs could be utilized to increase the light output or color gamut in a manner analogous to that discussed above. The same housing structure and driver circuit could be utilized by connecting the individual LEDs using wire bonds as discussed above.

The embodiments shown in FIG. 3 require the use of L-shaped leads and mating clips to provide the connections between the LED and the control circuitry. These parts increase the cost of the bulb both in terms of parts and assembly time. Refer now to FIG. 4, which is a cross-sectional view of a bulb 90 that utilizes a somewhat simpler connection scheme. Bulb 90 includes a housing 91 having a top surface 92 on which LED 75 is bonded in a manner analogous to that discussed above. Surface 92 includes two holes. A corresponding post that is attached to printed circuit board 97 protrudes through each hole as shown at 93 and 94. The diameter of the posts is sufficient to allow wire bonds to be attached to the top surface of each post. In one aspect of the invention, the posts include an insulating coating 95 on the vertical surface of the posts that prevents shorts from forming between the posts and housing 91, and hence, reduces the tolerance needed during assembly. The insulating coating reduces the tolerance needed in fitting the posts through the holes in surface 92. In this design, the posts are positioned within the holes when printed circuit board 97 is inserted into housing 91.

The post arrangement shown in FIG. 4 does not provide a mechanism for securing the printed circuit board within the housing. Printed circuit board 97 can be independently secured within housing 91 by an appropriate cap on end 77. In another aspect of the present invention, printed circuit board 97 is secured to housing 91 by a second post that is constructed from a plastic material that can be deformed by heating to form a rivet-like structure. Such a post is shown at 98. Post 98 is inserted through another hole in surface 92 and a heated surface applied to the end that protrudes through surface 92 to form a structure that secures printed circuit board 97 with respect to surface 92.

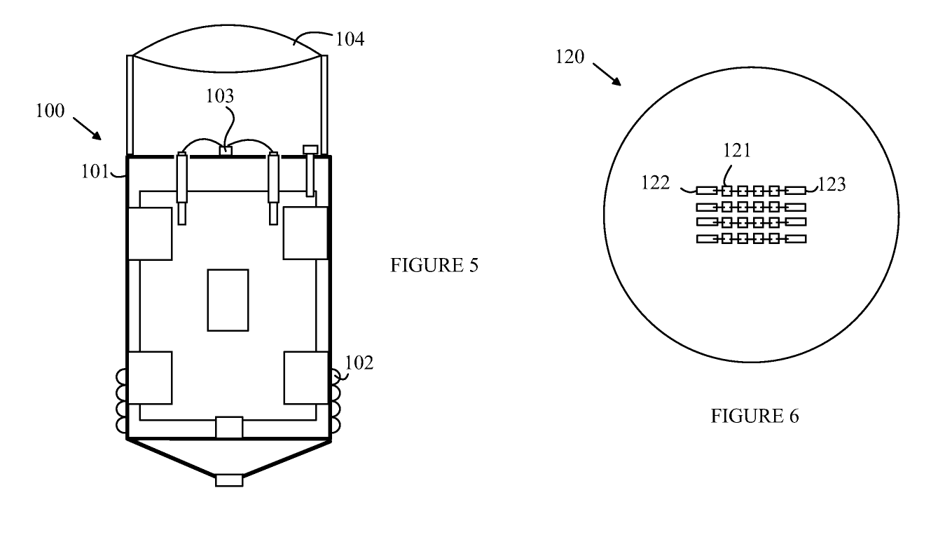

The above-described embodiments of the present invention utilize a housing that is shaped to replace a standard bulb of the type used in flashlights or the like. However, embodiments of the present invention that utilize other types of housings can also be constructed. Refer now to FIG. 5, which is a cross-sectional view of a light bulb 100 that has a housing 101 with a base that has screw threads 102. Light bulb 100 is adapted for use in a conventional screw-in light socket.

It should be noted that the above-described embodiments of the present invention are not to scale. In particular, the LEDs are shown as being significantly larger than typical LED containing dies. In practice, LED 103 is much smaller than the diameter of even a flashlight bulb, and hence, LED 103 appears to be a point source. Accordingly, the protective cap can also include optical elements 104 that focus or collimate the light from the bulb.

The above-described bulb embodiments of the present invention utilize single LEDs; however, embodiments that utilize multiple LEDs that are connected together using wire bonds can also be constructed. Refer now to FIG. 6, which is an end view of bulb 120 having a plurality of LEDs such as LED 121. The LEDs are arranged in 4 series strings in bulb 120 by connecting the LEDs in each string in series using wire bonds. Each string is powered via two contacts such as contacts 122 and 123. The contacts are routed to the inside of the bulb housing in a manner similar to that discussed above; however, the number of post or contacts that terminate on the printed circuit board within the bulb is now 8 instead of two.

The above-described embodiments of the present invention utilize some form of transparent cap to protect the LEDs from environmental damage. For the purposes of this discussion, a cap will be defined to be transparent if the cap transmits at least 50 percent of the light derived from the LEDs in the spectral band of interest.

The above-described embodiments of the present invention utilize LEDs that are directly connected to the heat-dissipating surface. An LED will be defined to be directly connected to the heat dissipating surface if the LED is bonded to the surface by a heat conducting adhesive with no intermediate layers of materials other than that adhesive.

The above-described embodiments of the present invention have been provided to illustrate various aspects of the invention. However, it is to be understood that different aspects of the present invention that are shown in different specific embodiments can be combined to provide other embodiments of the present invention. In addition, various modifications to the present invention will become apparent to those skilled in the art from the foregoing description and accompanying drawings. Accordingly, the present invention is to be limited solely by the scope of the following claims.

What is claimed is:

1. A light source comprising:
a housing having an interior compartment enclosed in an outer surface having a heat dissipating surface and first and second LED power terminals that are accessible from outside said interior compartment;
a first LED directly attached to said heat dissipating surface and electrically insulated therefrom, said first LED having first and second LED power contacts;
first and second housing power terminals disposed outside said housing, electrically isolated from said heat dissipating surface, said LED power contacts providing being powered when a potential difference is applied between said first and second housing power terminals;
a first conductor connecting said first LED power contact to said first LED power terminal; and
a second conductor connecting said LED second power contact to said second LED power terminal.

2. The light source of claim 1 further comprising a drive assembly electrically connected to said first and second housing power terminal and said first and second LED power terminals, said drive assembly being located in said interior compartment and providing power to said first and second LED power terminals.

3. The light source of claim 1 further comprising a protective cap covering said LED and said first and second conductors.

4. The light source of claim 3 wherein said protective cap comprises a transparent material.

5. The light source of claim 1 wherein said first and second LED power terminals comprise conducting members connected to said drive assembly that pass through first and second holes in said housing.

6. The light source of claim 5 wherein said first conducting member comprises a cylindrical conductor extending from said housing and having a cross-sectional area sufficient to accept a wire bond.

7. The light source of claim 1 wherein said first conductor comprises a wire bond.

8. The light source of claim 1 further comprising a second LED directly attached to said heat dissipating surface, said second LED being connected to said first LED by a wire bond.

9. A method for fabricating a light source comprising:
providing a heat dissipating surface;
directly attaching a plurality of LEDs to said heat dissipating surface, said LEDs being electrically isolated from said heat dissipating surface;
connecting two of said LEDs in series using wire bonds;
connecting said two of said LEDs to power terminals in said light source using wire bonds; and
covering said plurality of LEDs and said wire bonds with a transparent protective cover.

10. A device comprising:
a printed circuit board having a heat dissipating core;
a plurality of integrated circuit chips connected to said printed circuit board;
an LED mounting area comprising a portion of said printed circuit board in which said heat dissipating core is exposed; and
a plurality of LEDs attached directly to said heat dissipating core and electrically insulated therefrom, at least two of said LEDs being connected in series by a wire bond connected between said two LEDs, said LEDs being electrically connected to at least one of said integrated circuit chips.

11. The device of claim 10 wherein said device executes a function that is independent of the functioning of said LEDs.
